(19) United States
(12) Patent Application Publication
(10) Pub. No.: US 2002/0095817 A1
(43) Pub. Date: Jul. 25, 2002

(54) Method for treatment of sludge from water works

(76) Inventor: Lars-Olov Svedberg, Drottningholm (SE)

Correspondence Address: YOUNG & THOMPSON, 745 SOUTH 23RD STREET 2ND FLOOR, ARLINGTON, VA, 22202

(21) Appl. No.: 10/112,948

(22) Filed: Apr. 2, 2002

Related U.S. Application Data
(63) Continuation-in-part of application No. 09/582,581, filed on Aug. 25, 2000.
Application No. 09/582,581 is a 371 of international application No. PCT/SE98/02373, filed on Dec. 18, 1998.

(30) Foreign Application Priority Data
Dec. 29, 1997 (SE) 9704887-0

(51) Int. Cl. F26B 7/00

(52) U.S. Cl. 34/424; 34/418; 34/427

(57) ABSTRACT

A method for treatment of water works sludge. Water works sludge is a waste product that at present is returned to the recipient that the water works takes it water from. This cannot continue in the long run. The water works sludge must be taken care of. Significant for the method according to the invention is that the water works sludge is dried in a first step is dried, then the water works sludge is air-dried in a second step to a dry matter content of 30-80%. According to a preferred embodiment of the invention the dried water works sludge is further processed to an absorber, especially absorbers for oil or urine from cats, the dried water works sludge being crushed or subjected to further drying.

### TECHNICAL FIELD OF THE INVENTION

The present invention relates to a method for treatment of water works sludge.

### PRIOR ART

From RO 105 188 is previously known to use a sludge containing calcium carbonate as raw material. The sludge is dried and ground to powder and then it is used as an oil absorber. Thus, it is the question of an absorber that contains ground calcium carbonate, this being an essential difference compared to the present invention that starts out from water works sludge, see definition below.

From SE-C-500 661 is previously known a method and a device to produce nutriment pellets for plants from sewage sludge. Here it is on one hand a question of raw material in the shape of sewage sludge while the present invention starts out from water works sludge and on the other hand a soil improvement substance as a final product while the present invention relates to treatment of water works sludge that according to a preferred embodiment results in an absorber.

As regards absorbers used as cat litter, said absorbers are, as far as is known, not produced from a raw material in the shape of a waste product.

Objects and Features of the Invention

A primary object of the present invention is to set out a method for treatment of water works sludge, said sludge being defined below, said method being carried out during a relatively short time period. A further object of the invention is that the drying of the water works sludge is carried out in an environment friendly and energy saving way. A further object of the invention is that according to an embodiment of the invention an absorber is obtained as final product, said absorber being used in different utility applications.

### BRIEF DESCRIPTION OF THE DRAWINGS

Below, an embodiment of the invention will be described, reference being made to the accompanying drawings, wherein:

FIG. 1A shows a side view of a filter bed that is included in the equipment for carrying out the method according to the invention, said filter bed being in an initial position;

FIG. 1B shows a top view of the filter bed in the position according to FIG. 1A,

FIG. 2A shows a side view of the filter bed according to FIG. 1A, said filter bed being in a first end position;

FIG. 2B shows a top view of the filter bed in the position according to FIG. 2A;

FIG. 3A shows a side view of the filter bed according to FIG. 1A, said filter bed being in a second end position;

FIG. 3B shows a top view of the filter bed in the position according to FIG. 3A;

FIG. 4A shows a side view of the filter bed according to FIG. 1A, where a border of the filter bed has been deleted;

FIG. 4B shows a top view of the filter bed in the position according to FIG. 4A;

FIG. 5A shows a side view of the filter bed according to FIG. 1A, where a further step in the drying process has been effected;

FIG. 5B shows a top view of the filter bed in the position according to FIG. 5A;

FIG. 6A shows a side view of a set of drying grids at several levels;

FIG. 6B shows a top view of the set of drying grids according to FIG. 6A;

FIG. 7 shows a flow chart for producing an absorber for oil; and

FIG. 8 shows a flow chart for producing an absorber for urine from cats.

### DETAILED DESCRIPTION OF EMBODIMENTS OF THE INVENTION

The present invention thus refers to a method for treatment of a sludge that is taken out of a sedimentation basin at a water works, said sludge being called water works sludge and is a semi-organic product that normally consists to about 50% of metalhydroxide and to about 50% of humus substances from the raw water supply. Other compositions of the water works sludge are also possible within the scope of the invention.

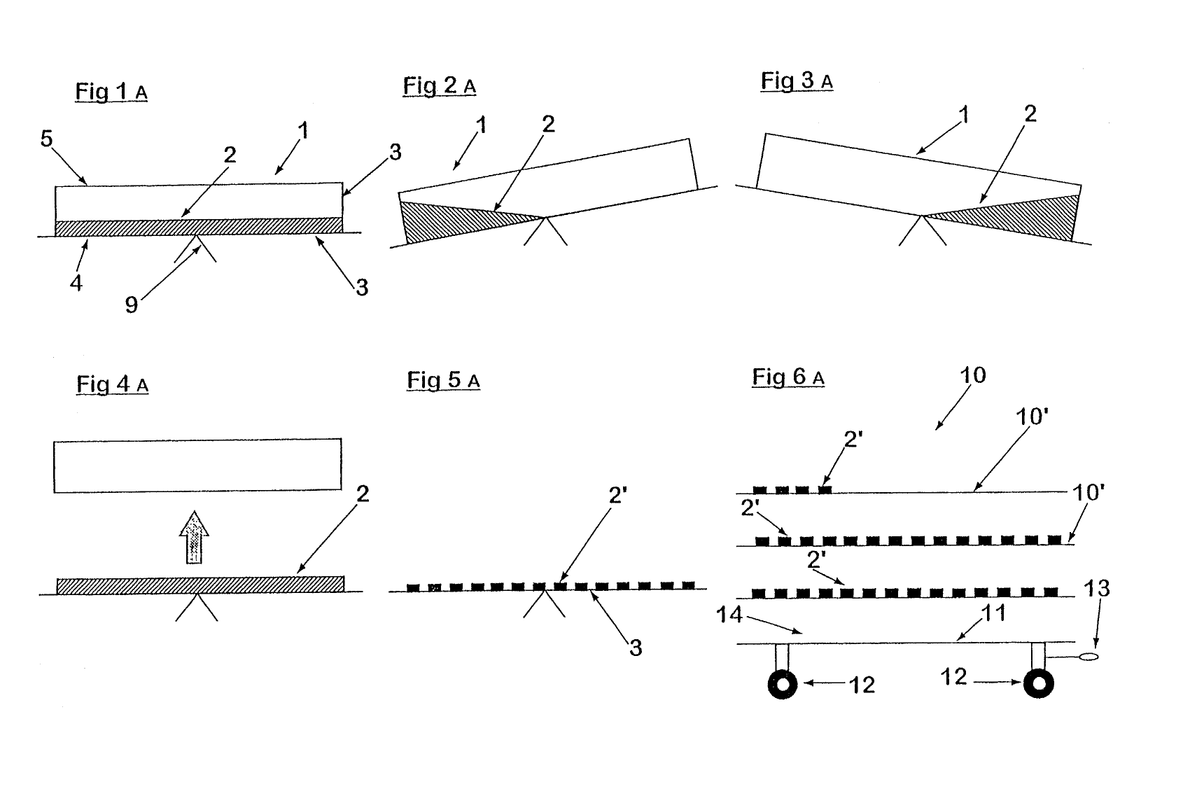

The first step of the method according to the invention is to air-dry the water works sludge, this being illustrated in FIGS. 1A-6B. The dry matter content of the sludge may vary a lot from one water works to another water works, the lighter the sludge the easier to separate the water from the sludge during the first time in the filter bed. Normally the water works sludge has a dry matter content of 1-4%, however it should be pointed out that within the scope of the invention the water works sludge may have dry matter contents outside said interval.

The raw material, i.e. the water works sludge 2, is transferred, preferably by pumping, from the sedimentation basin (not shown) to a filter bed 1, see FIGS. 1A-5B, said filter bed 1 comprising a rectangular cradle having a bottom 4 of filter cloth 3 and a border 5 resting on the bottom 4. According to the described embodiment also the border 5 is manufactured from filter cloth 3, said filter cloth 3 being attached to a frame (not shown). FIGS. 1A-5A are extremely schematic and therefore said figures do not show the frame of the bottom 4 that tenters the filter cloth 3.

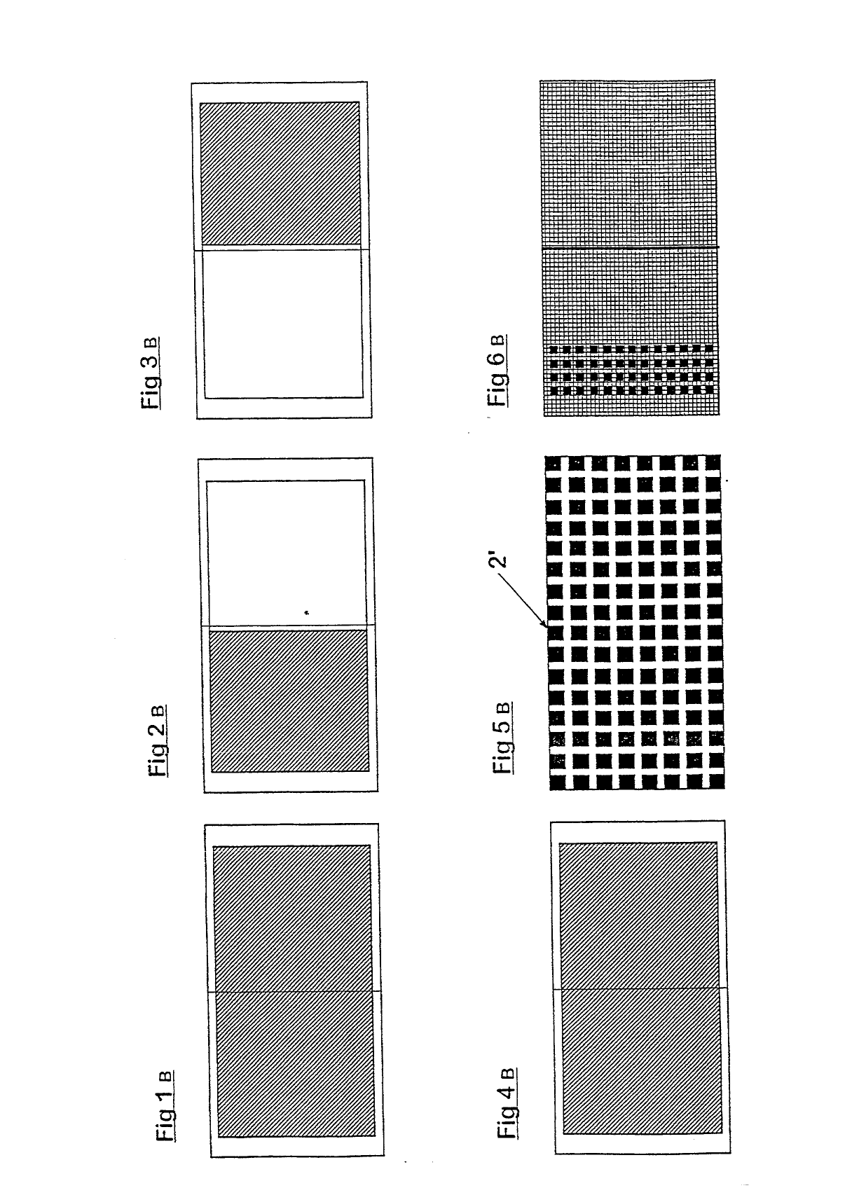

The V 9, turned upside down, at the mid-point of the lower side of the filter cloth 3 symbolises the pivoting point of the filter bed/the cradle 1. When water works sludge 2 has been pumped over to the cradle 1 to such a degree that 20% of its volume is filled the transfer of the sludge 2 is interrupted. Already when filling the cradle 1 a certain dewatering of the water works sludge 2 takes place. In order to effectively dewater the water works sludge 2 the cradle 1 is initially tilted to the left, see FIGS. 2A and 2B, to its first end position and then to the right, see FIGS. 3A and 3B, to its second end position. As especially is evident from FIGS. 2A and 3A the water works sludge 2 will be displaced from one end of the cradle to the other end of the cradle during said tilting. The cradle 1 is allowed to rest a certain time period at its respective end positions in order to make the water to flow through the filter cloth 3 both in the bottom 4 of the cradle 1 as well as in the border 5 of the cradle 1. The displacement mentioned above of the water works sludge 2 from one end to the other end has the effect that for each tilting to a respective end position the filter cloth 3 is self-cleansed, this being valid both for the filter cloth at the bottom of the cradle 1 and the filter cloth in the border 5. The tilting may continue as long as water is filtered away, this may continue up to an hour.

After this first dewatering step the border 5 is raised, see FIGS. 4A and 4B, and the dewatered water works sludge is allowed to rest at the filter cloth 3 of the bottom 4 during a certain time period that normally rests for about 3 hours. The water works sludge has now achieved such a dry matter content that it has developed into a sludge cake that may be equipped with grooves, such grooves forming a square pattern, see FIG. 5B, said grooves having the effect that a large sludge cake is divided into several smaller cubic sludge cakes 2′ that may rest and dry on the filter cloth 3 during a certain time period, normally about 20 hours or more. In exemplifying and non-restricting purpose it is stated that the sludge cake preferably has a thickness of about 5-10 cm. The grooves in the large sludge cake may preferably be effected by means of a rubber rake. The cubic shape is preferred in order to achieve a high dry matter content in short time. Preferably, this drying takes place in a space having a temperature between about 20° C. to 30° C., a fan (not shown) blowing air below the filter cloth 3 of the bottom 4.

The drying time for the cubic sludge cakes 2′ is dependent from that it must be possible to transfer the sludge cakes 2′ from the filter cloth 3 of the bottom 4 to a set of drying grids 10 at several levels. Preferably, said transfer of the cubic sludge cakes 2′ from the filter cloth 3 of the bottom 4 to the set of drying grids 10 may for instance be effected by scraping the cubic sludge cakes 2′ to a conveyer belt (not shown) that conveys the cubic sludge cakes 2′ to the set of drying grids where said cubic sludge cakes 2′ are transferred from the conveyor belt to the set of drying grids 10. Preferably, each drying grid 10′ may be pulled outwards like a drawer and the drying grids 10′ have a mesh size that is adapted in such a way that when the cubic sludge cakes 2′ reach a dry matter content of 75-80% their volume has decreased to such a degree that they fall through the drying grids 10′ and down to a collection plane 11 that in the embodiment according to FIG. 6A is provided with wheels 12 and a pull bar 13. Thus a transporting unit 14 for said cubic sludge cakes 2′ has been created and said sludge cakes 2′ are easily transported away. In this connection it should be pointed out that within the scope of the present invention it is also possible to interrupt the drying at a lower dry matter content, e.g. 30-50%. As will be explained below it might be preferred in connection with certain applications of the invention to interrupt the drying at a lower dry matter content. At which dry matter content the cubic sludge cakes 2′ fall down through the drying grids 10′ of course depends upon the selected mesh size, however it should be attended to that the mesh size is sufficiently fine to support the cubic sludge cakes 2′ when they are transferred from the filter cloth according to FIGS. 5A and 5B. From this reasoning it is realised that if the drying is interrupted before the cubic sludge cakes 2′ falls through the drying grids 10′, said cubic sludge cakes 2′ must be transferred in another way to the transporting unit 14.

Preferably, said drying takes place upon the set of drying grids 10 in a space with a temperature slightly above 20° C., most preferably from about 20° C. to about 30° C., a fan (not shown) blowing air through the drying grids 10′. In order not to affect the temperature condition in said space to an excessive degree, said space may be provided with a through-passing air lock for emptied and loaded transporting units 14. The air that exits the space should be directed into a bacterial bed for purifying of said air.

The time consumption for the entire drying process, i.e. from the pumping of the water works sludge 2 from the sedimentation basin until the cubic sludge cakes 2′ are collected upon the collection plane 11 of the transporting unit is about 3 days and nights if a dry matter content of 75-80% is to be achieved. Within the scope of the invention the entire drying process may be automatic. In exemplifying and non-restricting purpose it may be mentioned that as an alternative to the above described rubber rake a tool can be used that in one step divides the sludge cake into smaller units, preferably cubes.

The method described above, i.e. up to the manufacture of the cubic sludge cakes, represents the fundamental part of the present invention. It is namely quite conceivable that during certain circumstances there is no interest in further processing of the achieved product, i.e. the sludge cakes, but the substantial reduction in volume that is achieved by means of the fundamental part of the invention is completely sufficient to justify the method described above.

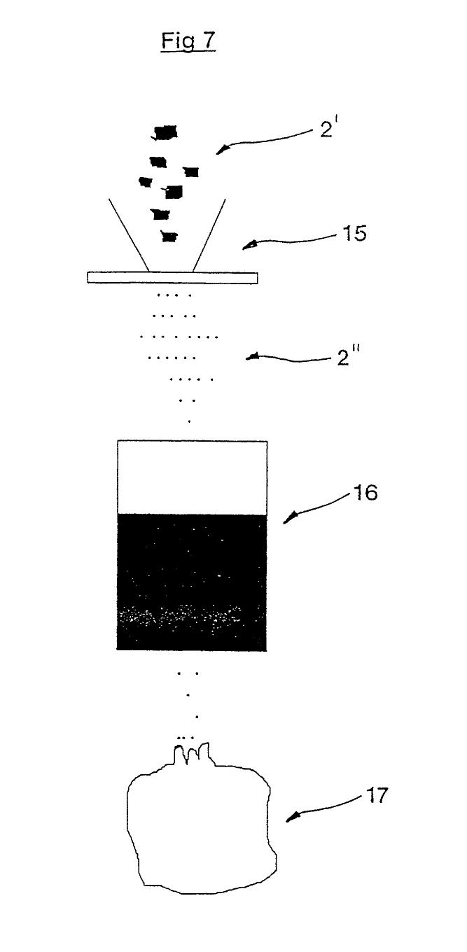

However, in many circumstances there is also a desire to produce a utility product from the water works sludge, preferably an absorber. The flow chart shown in FIG. 7 illustrates how an absorber, preferably for oil, is manufactured, said flow chart according to FIG. 7 starting out from the cubic sludge cakes 2′ whose drying process has been described above. In the embodiment according to FIG. 7 the cubic sludge cakes 2′ have a dry matter content of 75-80%. Said air-dried cubic sludge cakes 2′ are very hard and must be crushed in order to be pulverized, in the embodiment according to FIG. 7 this is effected by having the cubic sludge cakes 2′ fed into a crusher 15 driven by an electric motor, preferably an electric motor (not shown) is selected having a low energy consumption. The gravel 2″ obtained after crushing constitutes the final product and is collected in a storage reservoir 16. In the disclosed embodiment the final product/gravel 2″ is transferred into sacks 17, said sack-filled product constituting the product ready for delivery. Of course the sacks may have different volumes depending on the wishes of the customers.

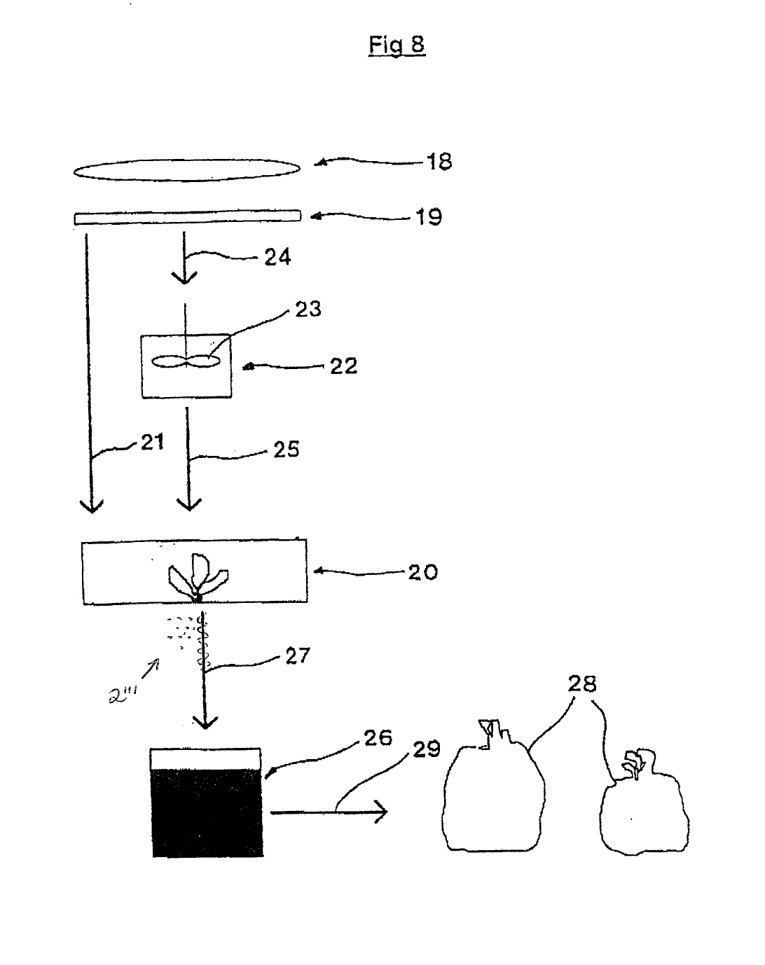

The flow chart shown in FIG. 8 illustrates how an absorber preferably for urine from cats, so-called cat litter, is manufactured, said flow chart according to FIG. 8 starting out from centrifugal treatment of the water works sludge, this being illustrated by the symbol 18. In the described embodiment this centrifugal treatment increases the dry matter content of the water works sludge 2 up to about 20%. Within the scope of invention the first step of air-drying, as described above, may be replaced by centrifugal treatment.

The sludge subjected to centrifugal treatment is then air-dried in principally the same way as has been described in connection with FIGS. 1A-6B, said air-drying being interrupted at a dry matter content of 30-50%. The air-drying is illustrated by the symbol 19. The cubic sludge cakes 2′ achieved by centrifugal treatment 18 and air-drying 19 may either directly be transferred to a drying oven/pelletizing plant 20, said transfer being illustrated by the arrow 21. In doing so a usually brown cat litter is achieved, said litter has not been added any colouring agents. The colour of the cat litter depends upon the composition of the water works sludge.

According to an alternative within the scope of the flow chart according to FIG. 8 the cubic sludge cakes 2′ may be transported to a dying reservoir 22 having an agitator 23, said transport being illustrated by the arrow 24. From the dying reservoir 22 the cubic sludge cakes 2′ are transported to the drying oven/pelletizing plant 20, this being illustrated by the arrow 25 in FIG. 8. The reason that the cubic sludge cakes 2′ according to one alternative are dyed, normally to a grey colour tone, is that according to certain experts the colour of the cat litter is extremely important in order to have the litter accepted by the cats. Preferably, natural colours are used. Generally, the dying makes the final product more expensive.

The drying oven/pelletizing plant 20 according to the shown embodiment is heated by gas or oil, but within the scope of the invention also electric drying ovens/pelletizing plants may for instance be used. In the drying oven/pelletizing plant 20 the dry matter content is increased to about 75-80% while the cubic sludge cakes 2′ are pulverized in particles having a size suitable to be used as an absorber, especially cat litter. The absorber/cat litter 2′″, in the shape of particles, is discharged from the drying oven/pelletizing plant 20 and transferred to a storage reservoir 26, said transfer being illustrated by the arrow 27. If a pelletizing plant is used a more uniform size of the particles is achieved.

From the storage reservoir 26 the absorber/cat litter 2′″ is transferred to a packaging line where the absorber/cat litter 2′″ is packed in sacks 28 of different sizes. The transfer of the absorber/cat litter 2′″ from the storage reservoir 26 to the packaging line is illustrated by the arrow 29.

Feasible Modifications of the Invention

The method described above and the means used thereby for air-drying of water works sludge 2 can be modified in several ways within the scope of the invention. Generally, the invention uses air-drying during some stage in order to increase the dry matter content of the water works sludge. In this connection it should be pointed out that during the air-drying, preferably no chemical thickeners are used. The produced sludge cakes do not need to be cubic.

It is general for the present invention that the initial stage of drying of the water works sludge may be performed in several different ways, air-drying and centrifugal treatment have been mentioned above. Within the scope of the invention it is also feasible to use other accepted methods for drying of the water works sludge. In exemplifying and non-restricting purpose filterbelt pressing, vacuum filtration and filter pressing may be mentioned.

Centrifugal treatment, air-drying and other methods for drying of water works sludge may thus be combined in several ways, beyond what has been exemplified above, in order to achieve different dry matter contents. Thus, the method according to the invention may start by centrifugal treatment or other alternative method of drying, then division into sludge cakes, preferably cubic, and finally air-drying. As regards the flow chart according to FIG. 8 it is feasible that the centrifugal treatment is deleted and that only air-drying precedes the subsequent drying in drying oven/pelletizing plant. Alternatively, it is feasible that the centrifugal treatment is exchanged for another accepted drying method for water works sludge.

What is claimed is:

1. A method for treatment of water works sludge comprising the steps of:
providing water works sludge consisting essentially of about 50% metal hydroxide and about 50% humus substances;
drying the water works sludge; and
air-drying the water works sludge at a temperature between about 20°-30° C. to a dry matter content of 30-80%.

2. A method for treatment of water works sludge comprising the steps of:
drying the water works sludge; and
air-drying the water works sludge at a temperature between about 20°-30° C. to a dry matter content of 30-80%.

3. The method according to claim 2, further comprising the step of dying the water works sludge.

4. The method according to claim 2, further comprising the step of dewatering the water works sludge through a filter cloth prior to said air-drying step.

5. The method according to claim 2, wherein said drying step comprises centrifugally treating the water works sludge.

6. The method according to claim 2, further comprising the step of dividing the water works sludge into smaller units.

7. The method according to claim 2, further comprising the step of blowing air using fans in said air-drying step.

8. The method according to claim 2, further comprising the step of crushing the water works sludge to produce an absorber.

9. The method according to claim 2, wherein said air-drying step comprises air-drying the water works sludge to dry matter content of 75-80%.

10. The method according to claim 9, wherein said air-drying step is for about 72 hours.

11. The method according to claim 2, further comprising the step of further drying the water works sludge to produce an absorber.

12. The method according to claim 12 wherein the step of further drying is performed in a drying oven.

13. The method according to claim 11 wherein the step of further drying is performed in a pelletizing plant.

14. A method for treatment of water works sludge comprising the step of air-drying only the water works sludge at a temperature between about 20°-30° C. to dry matter content of 30-80%.

15. The method according to claim 14 further comprising the step of crushing the water works sludge to produce an absorber.

16. The method according to claim 14 further comprising the step of further drying the water works sludge to produce an absorber.
